(19) United States
(12) Patent Application Publication
(10) Pub. No.: US 2023/0413830 A1
(43) Pub. Date: Dec. 28, 2023

(54) AUTOMATED FOOD COOKING SYSTEM

(71) Applicant: TECHMAGIC INC., Tokyo (JP)

(72) Inventors: Yuji SHIRAKI, Tokyo (JP); Shohei MAWATARI, Tokyo (JP); Jui PANN, Tokyo (JP)

(21) Appl. No.: 18/464,244

(22) Filed: Sep. 10, 2023

Related U.S. Application Data
(63) Continuation of application No. PCT/JP2022/008334, filed on Feb. 28, 2022.

(30) Foreign Application Priority Data
Mar. 11, 2021 (JP) 2021-039290

(51) Int. Cl. A21C 9/04; A21C 15/04; A21D 13/41; A21D 13/22; A21B 7/00

(52) U.S. Cl. CPC A21C 9/04; A21C 15/04; A21B 7/00; A21D 13/22; A21D 13/41

(57) ABSTRACT

An automated food cooking system is capable of cooking a plurality of kinds of foods in accordance with an order from a customer and includes an order reception device that receives the order from the customer, a food base preparation device that prepares a food base according to the order, a seasoning adding device, a topping device, a heat-cooking device, a distribution device, a transportation device that transports the food base, and a control device that is connected to each of the devices. The transportation device can transport the food base to at least a position of the food base preparation device, a position where the seasoning adding device adds a seasoning ingredient, a position where the topping device tops with a cooking ingredient, an input position and an output position of the heat-cooking device, and an input position and an output position of the distribution device.

### RELATED APPLICATIONS

The present application is a National Phase of International Application No. PCT/JP2022/008334 filed Feb. 28, 2022, which claims priority to Japanese Application No. 2021-039290, filed Mar. 11, 2021, the disclosures of which applications are hereby incorporated by reference herein in their entirety.

### FIELD

The present invention relates to a system for cooking foods automatically in accordance with orders from customers.

### BACKGROUND

In recent years, there has been a demand to automate service processes in restaurants due to the shortage of employees in restaurants and the like. There is also a demand for automation in food cooking systems, and technologies such as those described in Patent Literatures 1 and 2 have been proposed.

Patent Literature 1 describes a method of cooking a pizza by mechanical and automatic means, in which dough is shaped, sauce and toppings are added to the dough by a plurality of topping stations, and then the dough is heated by a baking station.

Patent Literature 2 describes a food preparation assembly line that allows customers to choose the kind of pizza through a web-based interface, and the food preparation assembly line uses a plurality of robots with arm tools to cook the kind of pizza ordered by the customer.

### CITATION LIST

### Patent Literature

[Patent Literature 1] Japanese Translation of PCT International Application Publication No. 2001-505064

[Patent Literature 2] Japanese Translation of PCT International Application Publication No. 2019-516358

### SUMMARY

### Technical Problem

Although the technology described in Patent Literature 1 can automatically cook pizzas, this technology can cook only the same kind of pizza; therefore, customers cannot choose the kind of pizza.

In contrast to this, the technology described in Patent Literature 2 allows customers to choose from a predetermined number of kinds of pizzas, but the range of choices available to customers is limited. Moreover, despite the limitation of customer's choice, the food preparation assembly line is a large-scaled system that involves a plurality of robots equipped with arm tools.

In view of this, an object of the present invention is to provide an automated food cooking system that can handle orders according to customer preferences, be applied to a variety of foods, save space, and be automated.

### Solution to Problem

The above-mentioned object of the present invention can be achieved by the following configuration. That is to say, an automated food cooking system according to an embodiment of the present invention is an automated food cooking system capable of cooking a plurality of kinds of foods in accordance with an order from a customer and includes an order reception device that receives the order from the customer, a food base preparation device that prepares a food base according to the order, a seasoning adding device that adds a seasoning ingredient according to the order to the food base, a topping device that tops the food base with a cooking ingredient according to the order, a heat-cooking device that heats and cooks the food base in accordance with the order, a distribution device that distributes the food base in accordance with the order, a transportation device that transports the food base, and a control device that is connected to each of the devices, in which the transportation device is able to transport the food base to at least a position of the food base preparation device, a position where the seasoning adding device adds the seasoning ingredient, a position where the topping device tops with the cooking ingredient, an input position and an output position of the heat-cooking device, and an input position and an output position of the distribution device.

### Advantageous Effects of Invention

Embodiments of the present invention provide an automated food cooking system that can handle orders according to customer preferences, be applied to a variety of foods, save space, and be automated.

### BRIEF DESCRIPTION OF DRAWINGS

FIG. 1 is a block diagram of an automated food cooking system.

FIG. 2 is a perspective view of a food base preparation device, a seasoning adding device, and a topping device in a first embodiment.

FIG. 3A is a plan view of FIG. 2, and FIG. 3B is a side view of FIG. 2.

FIG. 4 is a perspective view of a distribution device in the first embodiment.

FIG. 5 is a perspective view of a food base preparation device, a seasoning adding device, and a topping device in a second embodiment.

FIG. 6A is a plan view of FIG. 5, and FIG. 6B is a side view of FIG. 5.

FIG. 7 is an explanatory view about a cutting position in a third embodiment.

FIG. 8A to FIG. 8C illustrate a first example of the cutting position of a pizza.

FIG. 9A to FIG. 9C illustrate a second example of the cutting position of a pizza.

FIG. 10A to FIG. 10C illustrate a third example of the cutting position of a pizza.

FIG. 11A to FIG. 11C illustrate a fourth example of the cutting position of a pizza.

### DESCRIPTION OF EMBODIMENTS

An automated food cooking system according to embodiments of the present invention will hereinafter be described with reference to the drawings. However, the embodiments to be described below are examples of the automated food cooking system to embody the technical concept of the present invention and are not intended to specify the present invention to these. The present invention can be equally applied to other embodiments included in the scope of claims.

### First Embodiment

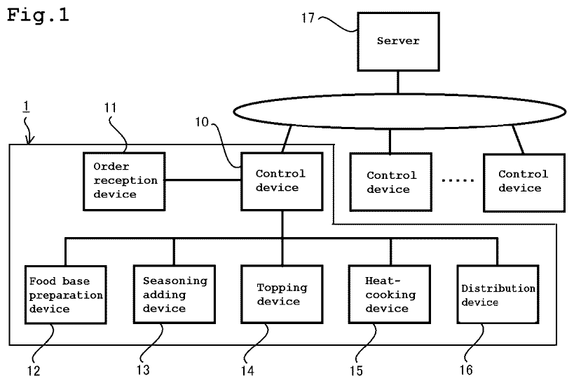

An automated food cooking system 1 according to a first embodiment of the present invention will be described with reference to FIG. 1 to FIG. 4. Although the first embodiment describes the automated food cooking system 1 that cooks pizzas as one example, this example is not limited to the cooking of pizzas and is applicable to the cooking of a variety of other foods.

FIG. 1 is a block diagram of the automated food cooking system 1. The automated food cooking system 1 includes a control device 10, and the control device 10 is connected to an order reception device 11, a food base preparation device 12, a seasoning adding device 13, a topping device 14, a heat-cooking device 15, and a distribution device 16. The order reception device 11 receives orders from customers and inputs the orders to the control device 10. In accordance with the order from a customer, the control device 10 controls the food base preparation device 12, the seasoning adding device 13, the topping device 14, the heat-cooking device 15, and the distribution device 16 to cook the food as ordered by the customer. Taking pizza as an example, the food base preparation device 12 prepares pizza dough according to the order from the customer, the seasoning adding device 13 adds a seasoning ingredient to the dough, the topping device 14 tops the dough with a cooking ingredient, the heat-cooking device 15 heats and cooks the dough topped with the cooking ingredient, the distribution device 16 causes a cutting unit 30 to cut the heated and cooked pizza, and thus, the completed pizza is served to the customer. In FIG. 1, means for transporting the dough or the pizza and means for serving the pizza to the customer are omitted.

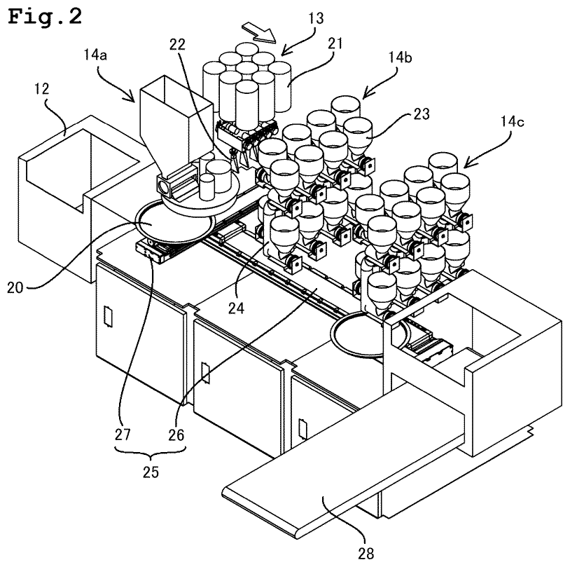

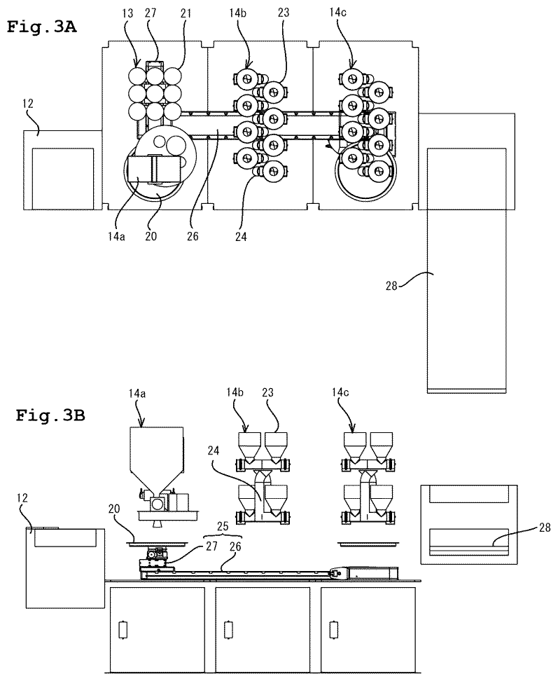

FIG. 2 is a perspective view of the food base preparation device 12, the seasoning adding device 13, and the topping device 14 in this embodiment, FIG. 3A is a plan view of FIG. 2, and FIG. 3B is a side view of FIG. 2. In FIG. 2, the topping device 14 includes three devices: a cheese serving device 14a, a first topping device 14b, and a second topping device 14c.

First, dough according to the order from the customer is placed on a tray 20 from a dough preparation device as the food base preparation device 12, and the dough is carried to a place below a sauce adding device as the seasoning adding device 13, where sauce is added to the dough by the seasoning adding device 13. The tray 20 is transported by an XY table 25 as described below.

The seasoning adding device 13 is equipped with sauce applying means 22 with a shape like a spatula, by which the added sauce is applied on the dough. The seasoning adding device 13 includes a plurality of sauce containers 21 (nine containers in FIG. 1), allowing a plurality of kinds of sauce to be added to the dough. It is also possible to add more than one kind of sauce to one dough. In this case, it is possible to apply more than one kind of sauce selectively depending on parts on the dough. For example, it is possible to apply four different kinds of sauce so as to divide the dough into four parts in a circumferential direction.

The tray 20 is then transported to a place below the cheese serving device 14a, where cheese is served on the dough. In the cheese serving device 14a, it is possible to serve, i.e., to put a plurality of kinds of cheese on the dough. It is also possible to serve multiple kinds of cheese on one dough. In this case, it is possible to serve multiple kinds of cheese depending on parts on the dough. For example, it is possible to serve the dough with four different kinds of cheese so as to divide the dough into four parts in the circumferential direction.

The tray 20 is then transported to a place below the first topping device 14b and the dough is topped with the cooking ingredients provided from a plurality of topping ingredient containers 23 (in FIG. 1, eight topping ingredient containers 23). The topping ingredient containers 23 of the first topping device 14b are arranged in a plurality of stages in a vertical direction and in a plurality of rows in a horizontal direction. In the horizontal direction, the topping ingredient containers 23 in the adjacent rows are disposed alternately to reduce dead space and occupied space. From the topping ingredient container 23 in the upper stage, the dough is topped with the cooking ingredient through an ingredient passage 24.

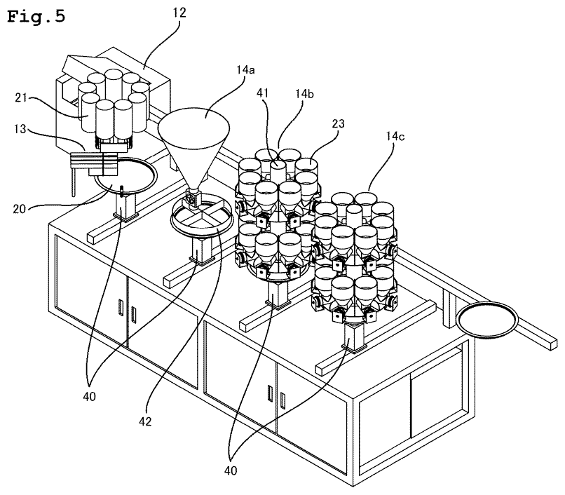

The tray 20 is carried by the XY table 25 to a place below each topping ingredient container 23 and adjusted so that the dough is topped with the cooking ingredient at a desired position. The first topping device 14b is capable of topping one dough with multiple kinds of cooking ingredients at desired positions. In this case, the dough can be topped with different kinds of cooking ingredients (or multiple cooking ingredients) depending on parts on the dough. For example, one dough can be topped with the cooking ingredients in four different patterns so as to divide the dough into four parts in the circumferential direction. At this time, using a topping frame 42 (see FIG. 5) enables neat topping in the four parts.

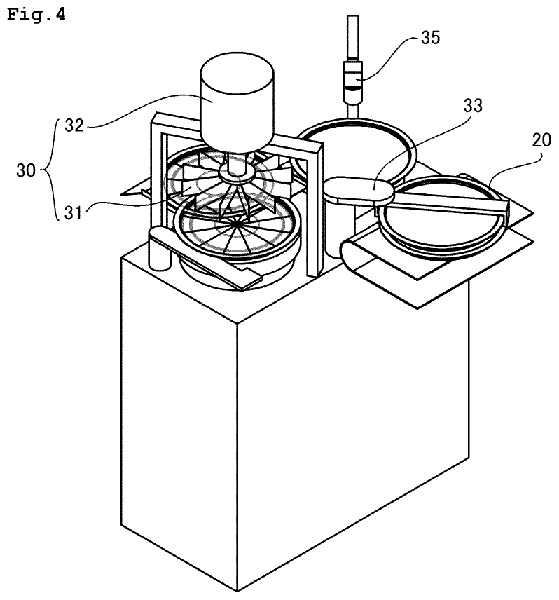

Since the topping ingredients are a design feature of the pizza and have a significant impact on the pizza's appearance, the kind of topping ingredients, the order of topping, and the location of topping are fully analyzed and determined using also information from a server 17, which is described below. Some kinds of topping ingredients are uniformly applied to the entire dough, while others are applied to only a part of the dough. Some topping ingredients should be arranged in such a way that the topping ingredients are not cut together with the dough when the dough is cut by the cutting unit 30 (FIG. 4) described below. For example, if the dough is topped with shrimp, the shrimp is placed so that the shrimp is not cut by the cutting unit 30.

The dough is then transported below the second topping device 14c and the dough is topped with the cooking ingredients provided from the topping ingredient containers 23 of the second topping device 14c. Since the second topping device 14c is similar to the first topping device 14b, the overlapping description is omitted. The topping by the second topping device 14c, like the topping by the first topping device 14b, is fully analyzed and determined also using the information from the server 17 as described below, because the topping is the design feature of the pizza. The dough is transported to the second topping device 14c after the first topping device 14b. For example, there are the following cases: the dough is transported to the first topping device 14b again, the dough goes back and forth between the first topping device 14b and the second topping device 14c a plurality of times, the dough is topped by the second topping device 14c first, the dough is topped by the first topping device 14b first, and various combinations of these cases. The order of topping is not necessarily uniform, and the kind of cooking ingredients in both topping devices 14b and 14c is set so that the second topping device 14c accommodates the cooking ingredients to be added relatively later than the first topping device 14b.

Next, the tray 20 with the topped dough thereon is transported from the XY table 25 to a conveyor 28, and the conveyor 28 transports the tray 20 to the heat-cooking device 15. Although an example in which the dough is transported together with the tray 20 is described in this embodiment, the dough may be conveyed without using the tray 20.

A structure of the XY table 25 is described here. The XY table 25 transports the tray 20 on a horizontal plane in an X-Y direction below the seasoning adding device 13, the cheese serving device 14a, the first topping device 14b, and the second topping device 14c. The XY table 25 has a Y-axis table 27 that is transported along an X-axis direction on an X-axis table 26. The Y-axis table 27 has a placement part 29 on which the tray 20 is placed, and the placement part 29 can be equipped with an electric motor to drive the tray 20 rotationally. Since the XY table 25 can transport the tray 20 to any position on the plane, there is no need to install an electric motor in the placement part 29. However, when applying sauce evenly to a circular pizza or adding cheese and other cooking ingredients in a circumferential pattern, for example, it is convenient to apply the sauce and toppings while driving the tray 20 rotationally. By driving the tray 20 on the X-Y plane with the XY table 25 and/or by driving the tray 20 rotationally, it is possible to apply sauce, serve cheese, and also add the topping ingredients to any position on the dough.

Although the tray 20 is described as being driven rotationally in the placement part 29 here, the embodiment is not limited to this example. In another example, a linear actuator can be installed in the placement part 29, which is useful for fine positioning of the tray 20, fine adjustment of the topping position, and so on. With a plurality of linear actuators installed in the placement part 29, fine positioning is further achievable in the planar direction.

The seasoning adding device 13 and the cheese serving device 14a are arranged side by side in the Y-axis direction. The seasoning adding device 13, the first topping device 14b, and the second topping device 14c are arranged side by side in the X-axis direction, and long sides of the first topping device 14b and the second topping device 14c are in accordance with the Y-axis direction in plan view. With this arrangement, the devices can be disposed in a smaller space. However, FIG. 2 illustrates one example of the arrangement of the devices, and this embodiment is not limited to this arrangement. This embodiment is applicable to various other layouts as long as the XY table 25 can transport the tray 20. Although the XY table 25 is illustrated as means of transporting the tray 20 on the horizontal plane, the transporting means in this embodiment is not limited to this XY table 25 and various other conveyance means can be used.

The dough transported by the conveyor 28 to the heat-cooking device 15 is heated and cooked in the heat-cooking device 15. The heat-cooking conditions are adjusted according to the kind and condition of the dough, the kind and condition of the sauce, the kind and condition of the cheese, the kind and condition of the topping ingredients, the season, weather, temperature, humidity, preparation conditions, crowded condition, serving time, etc. As the heat-cooking conditions, heating temperature, heating time, temporal patterns of the heating temperature, and the like are adjusted. The information from the server 17, which will be described below, is also used to adjust the heat-cooking conditions. The cooked pizza (in a baked state, it will be referred to as “pizza” rather than dough. This applies similarly to the description below) is placed on the tray 20 and in this state, transported to the distribution device 16.

FIG. 4 is a perspective view of the distribution device 16. The distribution device 16 includes the cutting unit 30, tray transporting means 33, and a photographing unit 35. The cutting unit 30 includes a cutter 31 and cutter driving means 32.

The cutter 31 cuts the pizza into a set number of pieces at set positions. For example, the cutter 31 has radial blades corresponding to the number of pieces to be cut, and the cutter 31 is vertically lowered by the cutter drive means 32, so that the pizza can be cut into a predetermined number of pieces. The cutter 31 is also configured to be horizontally adjustable, so that the position to cut the pizza can be adjusted. The cutter 31 may be interchangeable, in which case the cutter 31 can be selected according to the number of pieces to be cut and the size of the pizza. This allows the cutter 31 to cut the pizza according to the number of pieces to be cut (number of cuts) and the position to cut the pizza (cutting position), as calculated in third to fifth embodiments below.

Another example of the cutter 31 is a cutter with a single blade that is moved horizontally by the cutter driving means 32 to cut according to a set number of pieces at a set cutting position. The cutter 31 with a single blade is positioned horizontally to the cutting position, and the cutter 31 is lowered vertically by the cutter driving means 32 at the cutting position, so that the pizza can be cut at the set cutting position. If the cutter driving means 32 can control the cutter 31 to any position and posture in the horizontal direction, the cutter 31 can cut not only disc-shaped pizzas but also pizzas with other shapes, such as square-shaped pizzas as in the fifth embodiment below, for example, and square cutting is also achievable.

The tray transporting means 33 transports the tray 20 with the pizza thereon to a photographing position by the photographing unit 35. At the photographing position, the photographing unit 35 photographs the pizza condition. Here, a color still image camera is used as the photographing unit 35; however, a monochrome camera, a motion picture camera, an infrared camera, or the like can also be employed. Using the color camera can allow not only the shape of the pizza but also its color learned. Using the infrared camera can allow the temperature distribution of the pizza additionally to be learned.

The distribution device 16 analyzes images photographed by the photographing unit 35 and calculates the position to cut the pizza. This calculation can be performed by the distribution device 16, or some or all of this calculation can be performed by the control device 10. If the calculation load is distributed among the devices, it is possible to avoid the concentration of the calculation load on a particular device.

The distribution device 16 determines the position to cut the pizza on the basis of the image photographed by the photographing unit 35, taking into account the design quality of the pizza. For example, the pizza is cut at a position where the shrimp topped will not be cut. If, for example, the topping ingredients are topped in the four parts along the circumference by the topping device 14, the pizza is cut along the boundary lines of these four parts.

The video data photographed by the photographing unit 35 is not only used by the distribution device 16 to cut the pizza, but is also collected by the server 17 together with the pizza cooking information from the food base preparation device 12, the seasoning adding device 13, the topping device 14, and the heat-cooking device 15, the order data of the customer from the order reception device 11, and the like. These pieces of data are used by the server 17 to analyze the pizza quality, customer reputation, etc. At the server 17, various kinds of data including the image data collected from each control device are analyzed as big data. The big data is analyzed in conjunction with various data such as season, date, time of day, weather, temperature, humidity, event information, crowded condition, geographical location of each automated food cooking system 1, cooking scale, sales, customer base, and average customer spend. Machine learning using AI can be employed for such analysis, which can be used to increase the number of orders for each automated food cooking system 1, develop popular menus, and set suitable cooking conditions for each menu item.

The information analyzed by the server 17 is fed back to each control device 10 and used to control each automated food cooking system 1. For example, when the order reception device 11 tells customers information about popular menus, recommended menus, etc. in an interactive form, customer satisfaction can be improved, and furthermore, by increasing their willingness to purchase, the average customer spend can be increased. In the topping device 14, for example, when topping with various topping ingredients in accordance with the order from the customer, the topping recipe, topping order, topping position, and the like with high customer satisfaction can be set.

Since the order reception device 11 allows customers to order customized pizzas, it is possible to serve pizzas to suit the customer preferences further with a high degree of customer satisfaction compared to conventional selections from the existing menus. Although the order reception device 11 is not particularly limited, it is preferable to use a portable terminal such as a customer's own smartphone or tablet terminal, or a tablet terminal prepared by the automated food cooking system 1. For example, in the case of using the customer's own smartphone, the customer can order the pizza of his or her choice without being limited by time or location. When ordering to a store where the automated food cooking system 1 is installed, it is also possible to set a time to visit the store. Delivery will also be provided in conjunction with a delivery system. In addition, customers can register their favorite pizza recipes on their own portable terminals to make the next order easier, as well as share their original pizzas with others or register them as original pizzas with the store.

In this embodiment, the pizzas are circular in shape and have the same size; however, the embodiment is not limited to this example. Regarding the size of the pizza, the size of the dough can be selected or adjusted when the dough is supplied from the food base preparation device 12 to the tray 20. Although the size of the tray 20 is described as being the same for the sake of efficiency in transporting the tray 20, it is possible to handle the trays 20 with different sizes according to the specifications of a transportation device. In this example, the shape of the pizza is not limited to the circular shape only. Pizzas of any shape can also be cooked, such as square pizzas and semi-circular pizzas. It is also possible to cut pizzas with different sizes and shapes in the distribution device 16. The distribution device 16 includes the photographing device, so that a center position of cutting can be adjusted in accordance with the size and shape of the pizza. The mode of the cutter 31 in this example is not limited to a radial one; for example, a roller-type pizza cutter or the like can also be used.

The food base preparation device 12, the seasoning adding device 13, the topping device 14 (cheese serving device 14a, first topping device 14b, and second topping device 14c), the heat-cooking device 15, and the distribution device 16 in this embodiment are each unified, so layout changes, additions, omissions, etc. can be easily performed, making it possible to realize a layout that meets the needs of the work space. Although this example is described from the viewpoint of space saving, if there is room in the work space, it is possible to add more topping devices 14 or to install the respective devices in parallel. Furthermore, the food base preparation device 12 can provide dough prepared in advance, and if there is sufficient space, everything can be done automatically, starting with the preparation of the dough. On the other hand, if the work space is small, it can be handled by reducing the number of topping devices 14, for example.

### Second Embodiment

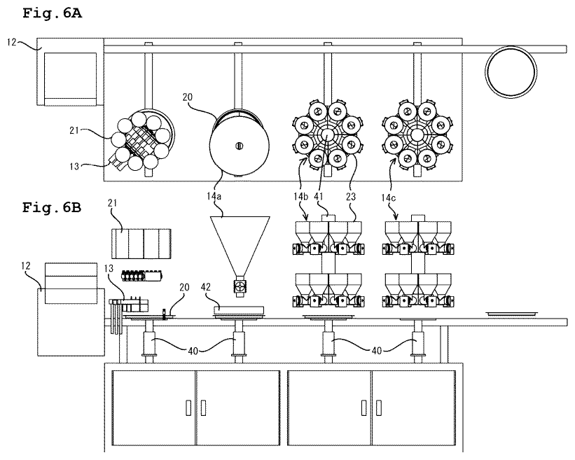

An automated food cooking system 1A according to a second embodiment of the present invention is described with reference to FIG. 5, FIG. 6A and FIG. 6B. The same reference signs are used for parts common to those in FIG. 1 to FIG. 4, and the description of such parts is omitted. The description of the structure and operation similar to those in the first embodiment is omitted here.

While the tray 20 with the dough thereon is transported by the XY table 25 in the automated food cooking system 1 in the first embodiment, tray placement parts 40 on each of which the tray 20 is placed in a manner of being able to be driven rotationally are provided at positions where the cooking ingredients are served from the seasoning adding device 13, the cheese serving device 14a, the first topping device 14b, and the second topping device 14c, and a transportation device (not illustrated) that transports the tray 20 among the food base preparation device 12, each tray placement part 40, and the entrance of the heat-cooking device 15 is provided in the automated food cooking system 1A in the second embodiment in the automated food cooking system 1A in the second embodiment. The mode of this transportation device is not limited in particular and, for example, the conveyor 28, an arm robot, or the like can be employed.

Each tray placement part 40 is equipped with an actuator such as an electric motor, and the tray 20 placed on the tray placement part 40 can be driven rotationally. Although the electric motor is given here as an example of the actuator, the present embodiment is not limited to this. As described in the first embodiment, one or more linear actuators can be used for fine adjustment of the position of the tray 20 linearly or planarly.

When the dough is supplied to the tray 20 from the dough preparation device as the food base preparation device 12, the dough, which is placed on the tray 20, is transported to the tray placement part 40 of the sauce adding device as the seasoning adding device 13, and the sauce is applied to the dough. Multiple kinds of sauce can be added similarly to the first embodiment.

The dough is then transported to the tray placement part 40 of the cheese serving device 14a, where the cheese is served on the dough. In the cheese serving device 14a, multiple kinds of cheese can be served similarly to the first embodiment.

The dough is then transported to the tray placement part 40 of the first topping device 14b, where the dough can be topped with the cooking ingredients from the topping ingredient containers 23 of the first topping device 14b. The first topping device 14b has the topping ingredient containers 23 arranged in multiple layers in an up-down direction and circumferentially in the horizontal direction. The cooking ingredients from the respective topping ingredient containers 23 are added at predetermined positions on the dough through an ingredient passage 41 disposed in the vertical direction at a center of the first topping device 14b. Although not limited in particular, the ingredient passage 41 can be used in common with each topping ingredient container 23 of the first topping device 14b, making it easier to adjust the topping position of the cooking ingredient.

Similarly to the first embodiment, the first topping device 14b is capable of topping one dough with multiple kinds of cooking ingredients at desired positions. For example, one dough can be topped with the cooking ingredients in four different patterns so as to divide the dough into four parts in the circumferential direction. At this time, using the topping frame 42 enables neat topping in the four parts.

The dough is then transported to the tray placement part 40 of the second topping device 14c, where the dough can be topped with the cooking ingredients from the topping ingredient containers 23 of the second topping device 14c. The operation of the second topping device 14c is similar to that of the first topping device 14b; thus, the description is omitted. The dough topped by the second topping device 14c is transported to the heat-cooking device 15 by the transportation device. The operations after this are similar to those in the first embodiment; thus, the description is omitted.

In the first embodiment, the tray placement parts 40 each for having the tray 20 thereon are provided at the positions where the cooking ingredients are served from the seasoning adding device 13, the cheese serving device 14a, the first topping device 14b, and the second topping device 14c, so that the trays 20 can be transported in parallel. Thus, sauce can be applied and the cooking ingredients can be added to more than one dough in parallel. That is to say, for example, in a case where the first tray 20 is placed on the tray placement part 40 of the second topping device 14c, the second tray 20 is placed on the tray placement part 40 of the first topping device 14b, the third tray 20 is placed on the tray placement part 40 of the cheese serving device 14a, the fourth tray 20 is placed on the tray placement part 40 of the seasoning adding device 13, and the dough is placed on the fifth tray 20 from the food base preparation device 12. Thus, to the dough placed on the trays 20, the sauce can be applied and the cooking ingredients can be added at the same time in parallel.

However, FIG. 5, FIG. 6A and FIG. 6B illustrate examples of the arrangement of the devices, and this embodiment is not limited to this arrangement. This embodiment is applicable to various other layouts as long as the trays 20 can be handled in parallel.

### Third Embodiment

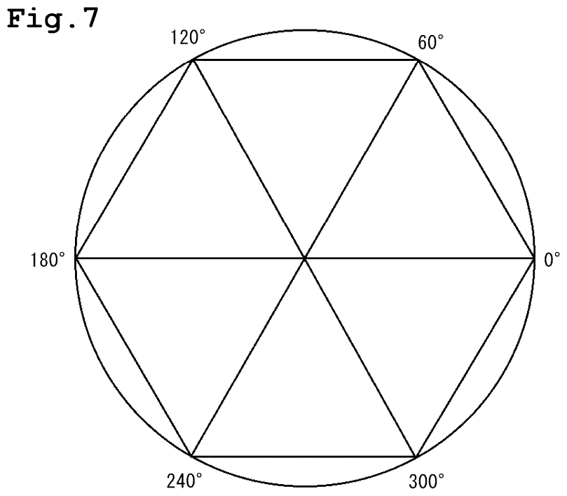

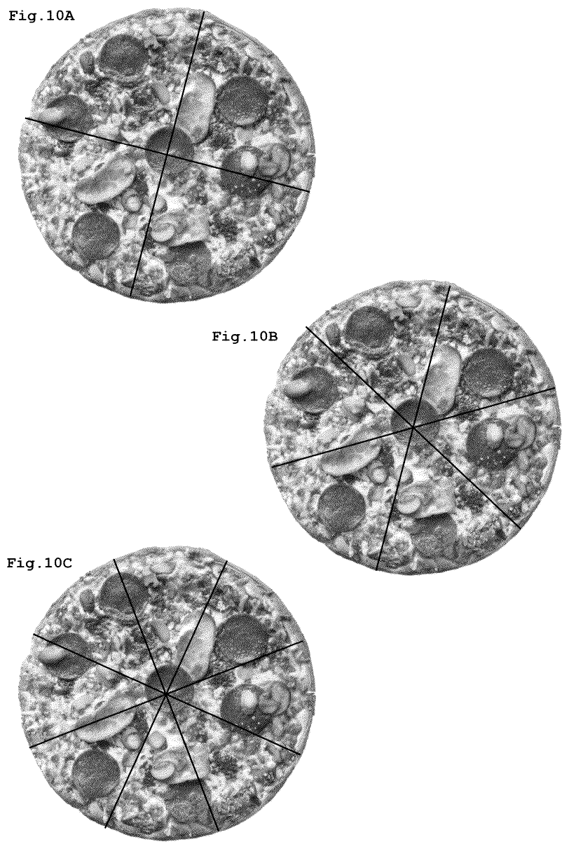

An automated food cooking system 1B according to a third embodiment of the present invention will be described with reference to FIG. 7 to FIG. 11C. The same reference signs are used for parts common to those in FIG. 1 to FIG. 6B, and the description of such parts is omitted. The description of the structure and operation similar to those in the first or second embodiment is omitted here.

This embodiment describes the calculation of the position to cut the pizza in the distribution device 16 (see FIG. 4) in the first or second embodiment. FIG. 7 is an explanatory view about the cutting position in this embodiment.

The distribution device 16 determines the position to cut the pizza on the basis of the image photographed by the photographing unit 35, taking into account the design quality of the pizza. For example, the cutting position is determined so that the ingredients are evenly distributed on each piece. Moreover, the pizza is cut along a position where, for example, the added shrimp will not be cut. If, for example, the topping ingredients are topped in the four parts along the circumference by the topping device 14, the pizza is cut along the boundary lines of these four parts.

The photographing unit 35 may be a 2D camera, a 3D camera, or a plurality of 2D cameras. When the 2D cameras are used, the added ingredients can be learned three-dimensionally, thus improving the accuracy of determining the ingredients. For example, 3DRA images can be employed as the 3D camera. Since the design quality of the pizza is also greatly affected by color, it is desirable to use the photographing unit 35 that can acquire color images as the photographing unit 35. Still images are used to determine the cutting position. Since the pizza is flat, e.g., disc-shaped, the pizza cutting position can be calculated with high accuracy even when video from the 2D camera is used. The following is an example of using a 2D camera capable of acquiring color (three-channel) image data as the photographing unit 35 in this embodiment.

In this example, although not limited in particular, the pizza cutting position is described as being calculated using the three-channel image data including red, green, and blue. The distribution device 16 includes a cutting position calculation unit (not illustrated). The cutting position calculation unit calculates the pizza cutting position according to the following procedure, based on the three-channel image data input from the photographing unit 35. The photographing unit 35 photographs the pizza from directly above.

(1) The pizza is photographed from directly above by the photographing unit 35, and the three-channel image data is input from the photographing unit 35 to the cutting position calculation unit.

(2) The number of pizza cuts is determined according to the operator's input or the customer's order. The number of cuts is not limited in particular, and in this example, the number of cuts is even. For example, the number of cuts can be set to 4, 6, 8, etc.

(3) Based on the input from the operator, the increment angle of scan as the increment amount when calculating the pizza cutting position is set. For example, if the number of pizza cuts is 6 and the increment angle is 5°, the following 12 angle patterns are calculated as candidates for the cutting position. The first in the candidate position list is the angle at which the calculation starts (see the cutting positions in FIG. 7).
[0, 60, 120, 180, 240, 300]
[5, 65, 125, 185, 245, 305]
[10, 70, 130, 190, 250, 310]
[55, 115, 175, 235, 295, 355]

Although not limited in particular, the angular position 0° of the origin is set when the actual pizza is photographed by the photographing unit 35, and the cutter 31 of the cutting unit 30 is positioned based on this origin position 0° in the distribution device 16. Methods for positioning the cutter 31 at the suitable cutting position that is calculated by the cutting position calculation unit include, for example, a method of adjusting the cutter driving means 32 in the circumferential direction, a method of adjusting the tray 20 installed below the cutter 31 in the circumferential direction, and the like. The angular position of the origin, 0°, is also reflected in the three-channel image data output from the photographing unit 35 and, for example, the angle indicated as 0° in FIG. 7 is set as the origin position.

(4) The size of the image is reduced to 256 px×256 px (unit px means pixels). By reducing the image size, the calculation time can be reduced compared to using full-scale images. Since this embodiment uses numerical calculation that focuses on color distribution and variation, there is no need to analyze the shape of detailed ingredients, and the accuracy of the calculation results can be maintained even when the image size is reduced.

(5) Regarding one cutting position in the candidate position list, a region of interest (ROI) is determined to be a triangular region for each piece. For example, when cutting into six pieces, six equilateral triangular ROIs are set as illustrated in FIG. 7. At this time, the ROI is set as a triangular region, based on a center point of the target pizza; therefore, an edge part of the pizza is excluded from the calculation target.

Since the pizza is placed on the tray 20 with the center of the pizza in accordance with the center of the tray 20, the center position of the pizza can be automatically calculated from the position of the tray 20. For example, when the pizza is disposed directly below the cutter 31, the tray 20 is positioned so that the center of the cutter 31 coincides with the center of the pizza. When the pizza exists at the imaging position of the photographing unit 35, the photographing unit 35 is fixed at the constant position so that the optical axis of the photographing unit 35 coincides with the vertical line at the center of the tray 20. Therefore, the center point of the pizza and the angular position of the origin, 0°, are accurately specified in the image data; accordingly, the cutting position calculation unit can properly learn the pizza position in the image data in relation to the actual distribution device 16.

(6) For each piece, the average of the RGB values is calculated for all pixels in the piece. For example, when cutting into six pieces, six average RGB values are obtained. If the number of pixels corresponding to one piece is, for example, 8,000, there are 8,000 R values, 8,000 G values, and 8,000 B values as data for the three channels, and based on these, the average of the 8,000 pieces of data for each of RGB is calculated and six sets of average RGB values are obtained. The six sets of average RGB values correspond to the three components of RGB; thus, in the actual example in (7) below, 18 pieces of numerical data are obtained.

(7) A standard deviation of the average RGB values is obtained. Since one average RGB value is a vector (array data) including R, G, and B components, for example, one value can be calculated as the standard deviation of six sets of array data created by the RGB data. A large difference among the average RGB values for each piece indicates that the ingredients are not uniform. As an example, the following calculation results are obtained. For example, the value of the standard deviation at the cutting position 0° is 47.54886193002255.
Start angle=0°.
[91.42418981, 134.62557870, 198.72569444]
[75.73900463, 126.39409722, 197.39236111]
[85.21990741, 132.25347222, 199.07754630]
[85.65227273, 131.17443182, 199.06363636]
[80.69450673, 128.12107623, 199.60762332]
[82.17832957, 129.42437923, 200.13318284]
Standard deviation=47.54886193002255

(8) The above (5) through (7) are repeated for all the cutting positions in the candidate position list.

(9) the cutting position calculation unit outputs the candidate with the smallest standard deviation from the candidate position list as the calculation result of the suitable cutting position.

(10) The distribution device 16 cuts the pizza by the method described in the first or second embodiment, based on the calculation result of the suitable cutting position obtained from the cutting position calculation unit.

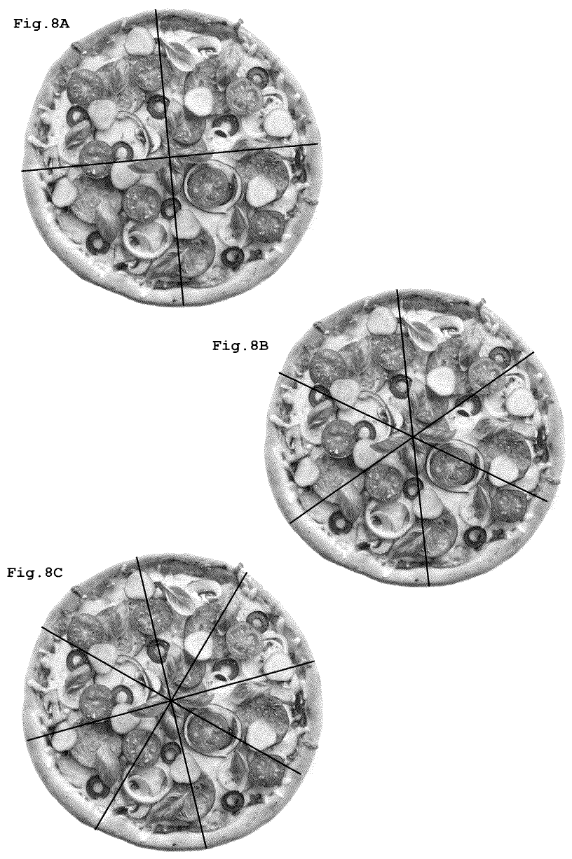

FIG. 8A to FIG. 11C illustrate first to fourth examples of pizza cutting positions, respectively. FIG. 8A to FIG. 11C illustrate examples in which the calculation results of the suitable cutting lines output from the cutting position calculation unit in accordance with the calculation method in this example are drawn schematically as images. In FIGS. 8A, 9A, 10A, 11A, the number of cuts is 4, in FIGS. 8B, 9B, 10B, 11B, the number of cuts is 6, in FIGS. 8C, 9C, 10C, 11C, the number of cuts is 8.

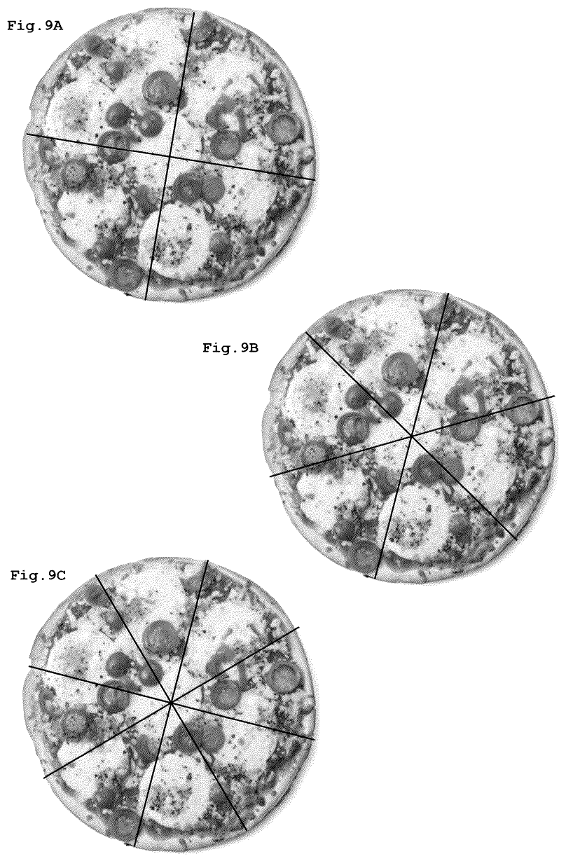

FIG. 8A to FIG. 8C illustrate the first example of the pizza cutting position. The lines of the cutting positions in FIG. 8A to FIG. 8C indicate that the tomatoes and basil are distributed to each piece in a balanced manner. Similarly, in the second to fourth examples of the pizza cutting positions illustrated in FIG. 9A to FIG. 11C, it can be understood that the ingredients are distributed in a balanced manner to each piece according to the number of cuts.

In FIG. 8A to FIG. 11C, M and L sizes are included as the sizes of pizzas, and the scale of the image of the pizza illustrated in the drawing is different from that of the actual pizza. Even in such a case, the pizza cutting position is calculated with all the pizza images reduced to an image size of 256 px×256 px in accordance with the aforementioned procedure (4). Therefore, according to this embodiment, it is possible to calculate the cutting position where the ingredients are evenly distributed in a balanced manner for pizzas of any size.

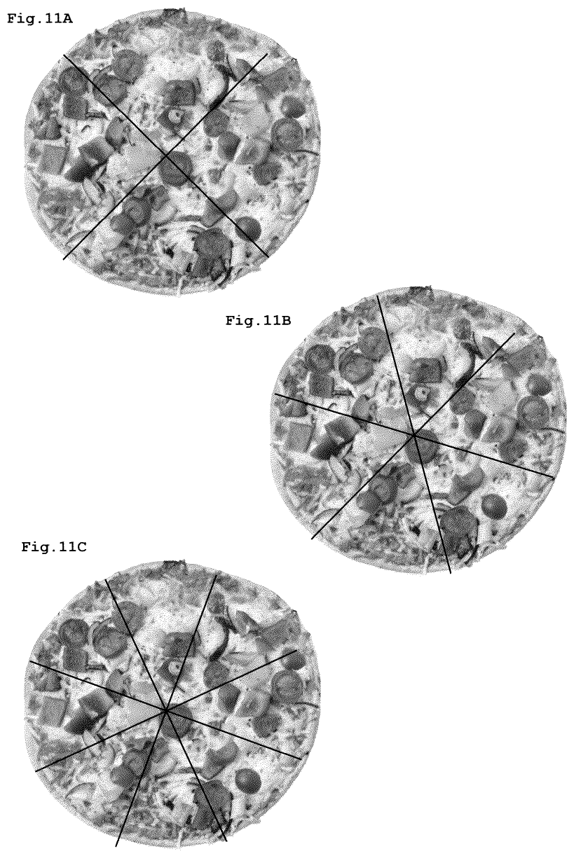

The ROI in FIG. 11A to FIG. 11C is a triangle formed by line segments each corresponding to the radius from the center of the tray 20 on which the pizza is placed (calculated as the average of the radii for the candidates of the cutting positions (e.g., the average of six radii in the case of six equal cuts)) and the start or end point of each line segment. Therefore, even if the shape of the pizza is not a perfect circle and the pizza is partially bulged or depressed in the periphery, the suitable cutting position can be calculated as appropriate from the standard deviation of the average RGB values.

If, for example, the topping ingredients are added by the topping device 14 so as to divide into four parts along the circumference, the boundary lines of the four parts are selected as the candidate with the smallest standard deviation among the candidate position list; therefore, the pizza can be cut suitably without deteriorating the good appearance that is considered at the time of topping. In addition, the even and balanced distribution of the ingredients to each piece allows the pizza to be cut at a position where, for example, the salami, shrimp, or the like topped will not be cut.

In the aforementioned procedure (3), the example with an increment angle of 5° is described, but the increment angle in this embodiment is not limited to this and can be determined according to the input from the operator, for example, between 0.1° and 15°. However, the relationship between the increment angle (scan angle) θs and the number of cuts Ns satisfies the following Equation (1), in which n represents the number of increments (n is an integer).

360/Ns=n·θs Equation (1)

In the aforementioned procedure (3), when the number of cuts is set in accordance with the operator's input or the customer's order, the cutting position calculation unit may automatically set the increment angle θs as the increment width or, for example, the operator may select the increment angle θs from large, medium, and small. In this case, if the number of divisions is 6, for example, the increment angle θs can be 15° as large, 5° as medium, and 1° as small.

### Fourth Embodiment

An automated food cooking system 1C according to a fourth embodiment of the present invention will be described. This embodiment is another embodiment of calculation of the pizza cutting position of the third embodiment. The same reference signs are used for parts common to those in FIG. 1 to FIG. 11C, and the description of such parts is omitted.

The method of calculating the cutting position in this embodiment differs from that in the third embodiment where the standard deviation of the average RGB values is obtained, in that the distribution of the colors of the cooking ingredients topped on the pizza is recognized. In this embodiment, when calculating the cutting position, it is not necessary to recognize even subtle tints, such as the pattern and color of basil leaves, for example. Therefore, the arrangement of the ingredients on the pizza is recognized by roughly distinguishing the colors, for example, distinguishing a red ingredient, a yellow ingredient, an orange ingredient, a green ingredient, a brown ingredient, a black ingredient, and the like. Then, with the distribution of the ingredients on the pizza learned, the cutting position to make the ingredients distributed in a balanced manner on each piece to be cut can be calculated in accordance with the following procedure (1A) to (10A).

(1A) The pizza is photographed from directly above by the photographing unit 35, and the three-channel image data is input from the photographing unit 35 to the cutting position calculation unit.

(2A) The number of pizza cuts is determined according to the operator's input or the customer's order. The number of cuts is not limited in particular, and in this example, the number of cuts is even. For example, the number of cuts can be set to 4, 6, 8, etc.

(3A) Based on the input from the operator, the increment angle θs of the scan as the increment amount when calculating the pizza cutting position is set. For example, if the number of pizza cuts is 6 and the increment angle θs is 5°, the following 12 angle patterns are calculated as candidates for the cutting position. The first in the candidate position list is the angle at which the calculation starts (see the cutting positions in FIG. 7).
[0, 60, 120, 180, 240, 300]
[5, 65, 125, 185, 245, 305]
[10, 70, 130, 190, 250, 310]
[55, 115, 175, 235, 295, 355]

(4A) The size of the image is reduced to 256 px×256 px. By reducing the image size, the calculation time can be reduced compared to using full-scale images. Since the ingredients are recognized as images by rough colors in this embodiment, there is no need to analyze the shape and color tone of the detailed ingredients. Thus, the accuracy of the calculation results can be maintained even when the image size is reduced.

(5A) For one cutting position in the candidate position list, the ROI is determined to be a triangular region for each piece. For example, when cutting into six pieces, six equilateral triangular ROIs are set as illustrated in FIG. 7. At this time, the ROI is set as a triangular region, based on a center point of the target pizza; therefore, an edge part of the pizza is excluded from the calculation target.

(6A) The ingredients topped on the pizza are classified into roughly six colors, for example, red, yellow, orange, green, brown, and black, and the shape and arrangement of these six-color ingredients are recognized as images, and for each piece, the number of pixels of each of the ingredients with the six colors in the piece is counted. In the image recognition of the ingredients, for example, an area enclosed by the color boundary line is recognized as one ingredient, except for the colors of pizza dough (wheat color) and cheese (white color). The colors corresponding to the ingredients in one piece are classified into six colors, and the number of pixels corresponding to each ingredient in the piece is totaled for each classified color. In the case of color determination based on the RGB values, for example, in order to roughly determine the colors in this totaling, the RGB value of the red color is widened and the color in the range of about (R, G, B)=(220 to 255, 0 to 102, and 0 to 102) is determined to be red. Similarly, the other colors also have the wider range of RGB values. In another example, the color corresponding to the ingredient is determined from among the six colors, based on the average RGB values of all the pixels in one ingredient obtained by the image recognition, and by assuming that all the pixels in the ingredient correspond to the determined color, the number of pixels for each color may be counted. In this manner, when the number of cuts is six, for example, the data about the number of pixels for six colors of ingredients per piece is obtained for six pieces in the actual example in (7A) below.

(7A) A standard deviation about the number of pixels of each of the ingredients with the six colors in each piece is obtained. For example, since the data about the number of pixels for six colors in one piece is a vector (array data), one value can be calculated as the standard deviation of the array data for six pieces, for example. A large difference among the number of pixels of the respective ingredients in each piece indicates that the ingredients are not uniform. A case where the number of cuts is 6 is described next as one example. A value of 333.48942178792487 is obtained as the standard deviation value when the cutting position is 0°.
Start angle =0′.
[952, 95, 92, 475, 761, 189]
[978, 89, 91, 483, 715, 182]
[929, 91, 87, 468, 753, 196]
[960, 93, 95, 478, 776, 191]
[948, 96, 93, 457, 780, 178]
[939, 98, 89, 491, 752, 190]
Standard deviation=333.48942178792487

(8A) The aforementioned (5A) through (7A) are repeated for all the cutting positions in the candidate position list.

(9A) The cutting position calculation unit outputs the candidate with the smallest standard deviation among the candidate position list as the calculation result of the suitable cutting position.

(10A) The distribution device 16 cuts the pizza by the method described in the first or second embodiment, based on the calculation result of the suitable cutting position obtained from the cutting position calculation unit.

In the calculation of the cutting position in the aforementioned procedure (9A), the determination “avoid overlapping of the ingredient on the cutting position” can be added. In this case, the number of ingredients that overlap with the cutting lines is defined as the number of overlaps between the ingredient and the cutting position, and the number of overlaps between the ingredient and the cutting position is counted in the procedure (6A), and the number of overlaps between the ingredient and the cutting position is totaled together with the standard deviation in the procedure (7A). Thus, the cutting of the ingredient at the cutting position due to the overlap between the ingredient and the cutting position can be avoided, and accordingly, the good appearance can be enhanced further and the pizza can be cut easily by the distribution device 16, that is, cutting is easy because there is no need to cut any hard ingredient, for example, and smooth cutting of the pizza with a desired cutting surface is achievable.

Here, in the case where the suitable cutting position is the position where the standard deviation is smaller and the number of overlaps between the ingredient and the cutting position is smaller in the candidate position list, for example, the position at which the numeral totaling the smaller rank of the standard deviation and the smaller rank of the number of overlaps between the ingredient and the cutting position is the smallest is output as the calculation result of the suitable cutting position. If the rank is the same, for example, the position where the number of overlaps between the ingredient and the cutting position is smaller is output as the calculation result of the suitable cutting position.

In the above procedure (9A), the cutting position of the pizza can be calculated based only on the number of overlaps between the ingredient and the cutting position totaled in the procedure (6A). When topping a pizza with each ingredient, each ingredient is usually placed in consideration of the number of cuts according to the order of the pizza. Therefore, the suitable cutting position can be calculated by selecting the candidate with the smallest number of overlaps between the ingredient and the cutting position from the candidate position list.

In the above procedure (6A), the colors of the ingredients are roughly divided into six colors and the image recognition is performed; however, this example is not limited to this. In another example, the colors may be divided into four colors of red, green, brown, and black, or various other settings are available. In still another example, the colors may be set by the input from the operator. Although not particularly limited, the image recognition in this embodiment can employ, for example, well-known deep learning, etc.

### Fifth Embodiment

An automated food cooking system 1D according to a fifth embodiment of the present invention will be described. This embodiment is another embodiment of the calculation method for the cutting position in the third or fourth embodiment. The same reference signs are used for parts common to those in FIG. 1 to FIG. 11C, and the description of such parts is omitted.

In the third or fourth embodiment, the pizza is described as having a disc-like shape; however, in this embodiment, the shape of the pizza is not limited to a disc (a flat shape whose outer diameter is substantially circular) and also includes, for example, a square shape (a flat shape whose outer diameter is substantially square).

In the case of square pizzas, cutting in a grid shape, or so-called square cutting, is performed. In the case of the square cutting, the ROI is square-shaped (rectangular). The number of cuts in this square cutting is determined based on the operator's input or the customer's order. In one example, when a square pizza is cut into four pieces, the pizza is cut along cross-shaped cutting lines (one horizontal line and one vertical line). In another example, when a horizontally long rectangular pizza is cut into 8 pieces, the pizza is cut along one horizontal line and three vertical lines.

In the case of cutting a horizontally long rectangular pizza, if the operator or the customer instructs the automatic setting or if the operator or the customer does not instruct the number of cuts, the cutting position calculation unit sets, as the candidates of the cutting position, for example, cutting into four pieces (2 vertically×2 horizontally), cutting into six pieces (2×3, similarly), cutting into eight pieces (2×4, similarly), cutting into nine pieces (3×3, similarly), cutting into twelve pieces (3×4, similarly), and so on automatically. Then, similarly to the third embodiment, for each candidate of the cutting position, the average of the RGB values for all pixels in the piece is calculated for each piece. The cutting position calculation unit calculates the standard deviation of this average RGB value and outputs the candidate with the smallest standard deviation among the candidate position list as the calculation result of the suitable cutting position.

The cutting position calculation unit can also output the calculation result of the suitable cutting position by the calculation similar to that in the fourth embodiment. In this case, the calculation result of the suitable cutting position is output from the candidate position list by, for example, obtaining the standard deviation about the number of pixels of each of the ingredients with the six colors in each piece, counting the number of overlaps between the ingredient and the cutting position, and so on.

In this embodiment, the distribution device 16 can also cut the disc-shaped pizza into a square shape. In this case, the cutting position calculation unit outputs the calculation result of the suitable cutting position using the square ROI and using the grid-shaped cutting line pattern as the candidate of the cutting position, similarly to the third or fourth embodiment.

In a case where the dough preparation device as the food base preparation device 12 can prepare the dough in the shape set in accordance with the order from the customer, the distribution device 16 can cut the pizza into not just the set shape, the disc-like shape, or the square shape but also, for example, a rhomboid shape, an elliptical shape, a heart shape, or the like. In this case, the ROI according to the cutting shape of the pizza is set in accordance with the operator's input or the customer's order or automatically by the control device 10, and the distribution device 16 cuts the pizza to satisfy the set shape, number of pieces, and cutting position.

Some embodiments of the present invention have been described as above; however, these embodiments merely illustrate the automated food cooking system for embodying the technical concept of the present invention and are not to specify the present invention to these embodiments. The present invention is also applicable equally to other embodiments. A part of these embodiments can be omitted, added, or changed, and aspects of the embodiments can be combined with each other. For example, the distribution device 16 is described as cutting the pizza, but the distribution device 16 can also be used alone, and can be used to distribute foods other than pizzas, such as cakes and pies.

1. An automated food cooking system capable of cooking a plurality of kinds of foods in accordance with an order from a customer, the automated food cooking system comprising:
an order reception device that receives the order from the customer;
a food base preparation device that prepares a food base according to the order;
a seasoning adding device that adds a seasoning ingredient according to the order to the food base;
a topping device that tops the food base with a cooking ingredient according to the order;
a heat-cooking device that heats and cooks the food base in accordance with the order;
a distribution device that distributes the food base in accordance with the order;
a transportation device that transports the food base; and
a control device that is connected to each of the devices, wherein
the transportation device is able to transport the food base to at least a position of the food base preparation device, a position where the seasoning adding device adds the seasoning ingredient, a position where the topping device tops with the cooking ingredient, an input position and an output position of the heat-cooking device, and an input position and an output position of the distribution device.

2. The automated food cooking system according to claim 1, wherein the order reception device has a communication function and is able to receive the order from the customer remotely.

3. The automated food cooking system according to claim 1, wherein the order reception device is able to receive the order from the customer in an interactive form.

4. The automated food cooking system according to claim 1, wherein addition of the seasoning ingredient by the seasoning adding device and/or topping with the cooking ingredient by the topping device is able to be performed in a different mode in a part of the food base in accordance with the order.

5. The automated food cooking system according to claim 1, wherein the heat-cooking device adjusts a heating time and/or heating temperature in accordance with at least one mode of the food base, the seasoning ingredient, and the topping.

6. The automated food cooking system according to claim 1, wherein the distribution device includes a cutting unit that cuts the food base.

7. The automated food cooking system according to claim 6, wherein
the distribution device includes
a photographing unit that photographs the food base, and
a cutting position calculation unit that calculates a cutting position of the food base in accordance with a mode of the cooking ingredient topped by the topping device, based on image data input from the photographing unit, and
the cutting unit adjusts the cutting position of cutting the food base in accordance with the cutting position calculated by the cutting position calculation unit.

8. The automated food cooking system according to claim 7, wherein the cutting position calculation unit calculates the cutting position of the food base using, as an evaluation value, an average RGB value of each piece of the food base or a color distribution of the cooking ingredient topped on the food base.

9. The automated food cooking system according to claim 7, wherein
the cutting position calculation unit sets a first region of interest and a second region of interest, each of which is a triangular or rectangular region, as regions of interest, and calculates an evaluation value for each of the regions of interest,
the first region of interest is set based on an origin of the image data, and
the second region of interest is a region shifted from the first region of interest by a predetermined increment amount.

10. The automated food cooking system according to claim 7, wherein
information photographed by the photographing unit and information from the order reception device and at least one of the food base preparation device, the seasoning adding device, the topping device, the heat-cooking device, and the distribution device are collected by a server,
the server analyzes a mode of a food to be served to the customer, and
the analyzed information is provided to at least one of the order reception device, the food base preparation device, the seasoning adding device, the topping device, the heat-cooking device, and the distribution device.

11. The automated food cooking system according to claim 1, wherein
the food base is dough,
the seasoning ingredient is sauce,
the cooking ingredient topped is an ingredient including cheese, and
the automated food cooking system cooks a pizza.

12. An automated food cooking method capable of cooking a plurality of kinds of foods in accordance with an order from a customer, the automated food cooking method comprising:
a step of, by an order reception device, receiving the order from the customer;
a step of, by a food base preparation device, preparing a food base according to the order;
a step of, by a seasoning adding device, adding a seasoning ingredient according to the order to the food base;
a step of, by a topping device, topping the food base with a cooking ingredient according to the order;
a step of, by a heat-cooking device, heating and cooking the food base in accordance with the order;
a step of, by a distribution device, distributing the food base in accordance with the order; and
a step of, by a transportation device, transporting the food base, wherein
in the step of transporting the food base, the transportation device is able to transport the food base to at least a position of the food base preparation device, a position where the seasoning adding device adds the seasoning ingredient, a position where the topping means tops with the cooking ingredient, an input position and output position of the heat-cooking device, and an input position and an output position of the distribution device.

13. A program causing a computer to control each device in at least one step in the automated food cooking method according to claim 12.

14. A storage medium storing the program according to claim 13 therein.
